(19) United States
(12) Patent Application Publication
(10) Pub. No.: US 2023/0273478 A1
(43) Pub. Date: Aug. 31, 2023

(54) DISPLAY DEVICE

(71) Applicant: Japan Display Inc., Tokyo (JP)

(72) Inventor: Shimon ITAKURA, Tokyo (JP)

(73) Assignee: Japan Display Inc., Tokyo (JP)

(21) Appl. No.: 18/173,074

(22) Filed: Feb. 23, 2023

(30) Foreign Application Priority Data
Feb. 25, 2022 (JP) 2022-028057

(51) Int. Cl. G02F 1/1335

(52) U.S. Cl. CPC G02F 1/133601; G02F 1/133531

(57) ABSTRACT

According to one embodiment, a display device includes a liquid crystal display panel including a first polarizer, a second polarizer, and a first effective area in which a plurality of first pixels are provided, a dimming panel, and an adhesive layer provided between the liquid crystal display panel and the dimming panel, wherein the adhesive layer is in contact with the first polarizer, the adhesive layer overlaps the first effective area, entirely, and a length of the adhesive layer along the first direction is less than a length of the first polarizer along the first direction.

### CROSS-REFERENCE TO RELATED APPLICATIONS

This application is based upon and claims the benefit of priority from Japanese Patent Application No. 2022-028057, filed Feb. 25, 2022, the entire contents of which are incorporated herein by reference.

### FIELD

Embodiments described herein relate generally to a display device.

### BACKGROUND

In recent years, in order to improve the contrast of display devices, such technology has been developed, which uses a display panel for dimming light in addition to a display panel for displaying images.

### BRIEF DESCRIPTION OF THE DRAWINGS

FIG. 1 is an exploded perspective view schematically showing a configuration of a display device comprising two display panels.

FIG. 2 is a cross-sectional view of a display device according to a comparative example.

FIG. 3 is a cross-sectional view of a display device according to a comparative example.

FIG. 4 is a cross-sectional view of a display device in which an adhesive layer protrudes out.

FIG. 5 is a cross-sectional view schematically showing an example of the display device of the embodiment.

FIG. 6 is a cross-sectional view showing a processing step of adhering a liquid crystal display panel to a display panel.

FIG. 7 is a plan view schematically showing an example of the display device of this embodiment.

### DETAILED DESCRIPTION

In general, according to one embodiment, a display device comprises a liquid crystal display panel comprising: a first substrate, a second substrate opposing the first substrate, a first polarizer attached to a surface of the first substrate, which is on an opposite side to a surface opposing the second substrate, a second polarizer attached to a surface of the second substrate, which is on an opposite side to a surface opposing the first substrate, a first liquid crystal layer provided between the first substrate and the second substrate, and a first effective area in which a plurality of first pixels are provided; a dimming panel; and an adhesive layer provided between the liquid crystal display panel and the dimming panel, wherein the adhesive layer is in contact with the first polarizer, the adhesive layer overlaps the first effective area, entirely, and a length of the adhesive layer along the first direction is less than a length of the first polarizer along the first direction.

An object of the embodiments is to provide a highly reliable display device that can prevent a defective appearance.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The following is a detailed description of a display device according to one embodiment with reference to the drawings.

In the embodiments, a first direction X, a second direction Y and a third direction Z are orthogonal to each other, but may intersect at an angle other than 90 degrees. In the following descriptions, a direction towards a tip side of an arrow in the third direction Z is defined as above or upwards, and a direction opposite to the direction towards the tip side of an arrow in the third direction Z is defined as below or downwards. Note that the first direction X, the second direction Y and the third direction Z may as well be referred to as an X direction, a Y direction and a Z direction, respectively.

With such expressions “a second member above a first member” and “a second member below a first member”, the second member may be in contact with the first member or may be remote from the first member. In the latter case, a third member may be interposed between the first member and the second member. On the other hand, when “the second member on the first member” and “the second member underneath the first member”, the second member is in contact with the first member.

Further, it is assumed that there is an observation position to observe the display device on the side of the tip of the arrow in the third direction Z. Here, viewing from this observation position toward an X-Y plane defined by the first direction X and the second direction Y is referred to as plan view. Viewing the cross-section of the display device in an X-Z plane defined by the first direction X and the third direction Z or in a Y-Z plane defined by the second direction Y and the third direction Z is referred to as cross-sectional view.

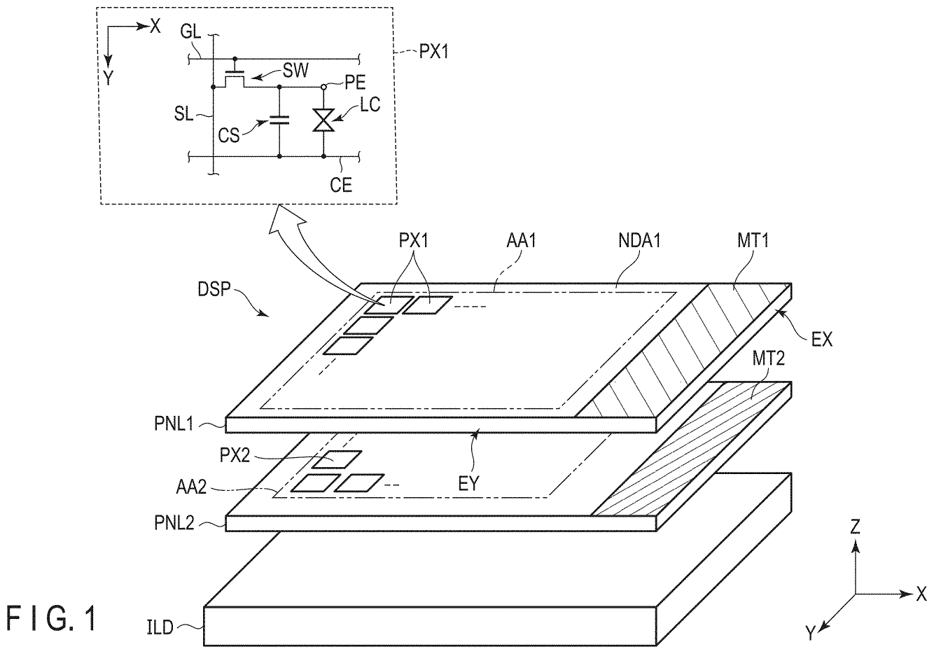

FIG. 1 is an exploded perspective view showing a configuration of a display device comprising two display panels. FIG. 1 shows a three-dimensional space defined by the first direction X, the second direction Y perpendicular to the first direction X and the third direction Z perpendicular to the first direction X and the second direction Y.

As shown in FIG. 1, a display device DSP comprises a liquid crystal display panel PNL1, a dimming panel PNL2 and an illumination device ILD. As shown in FIG. 1, by disposing the dimming panel PNL2 between the liquid crystal display panel PNL1 and the illumination device ILD, the contrast of images displayed on the liquid crystal display panel PNL1 can be improved.

The liquid crystal display panel PNL1 is, for example, rectangular. In the example illustrated, a short side EX of the liquid crystal display panel PNL1 is parallel to the first direction X, and a long side EY of the liquid crystal display panel PNL1 is parallel to the second direction Y. The third direction Z corresponds to the thickness direction of the liquid crystal display panel PNL1. The main surface of the liquid crystal display panel PNL1 is parallel to the X-Y plane defined by the first direction X and the second direction Y. The liquid crystal display panel PNL1 includes an effective area AA1 (display area) and a non-display area NDA1 located on an outer side the effective area AA1. The non-display area NDA1 includes a terminal area MT1 where a driver IC and a flexible wiring board are mounted. In FIG. 1, the terminal area MT1 is indicated by shading lines.

The effective area AA1 is an area for displaying images and comprises a plurality of pixels PX1, for example, arranged in a matrix along the first direction X and the second direction Y. As shown enlarged in FIG. 1, each pixel PX1 is disposed in a region compartmentalized by scanning lines GL and signal lines SL, and comprises a switching element SW, a pixel electrode PE, a common electrode CE, a liquid crystal layer LC and the like.

The switching element SW is constituted by a thin-film transistor (TFT), for example, and is electrically connected to a respective scanning line GL and a respective signal line SL. Each scanning line GL is electrically connected to the switching elements SW of those of the pixels PX1 aligned along the first direction X. Each signal line SL is electrically connected to the switching elements SW of those of the pixels PX1 aligned along the second direction Y. The pixel electrode PE is electrically connected to the respective switching element SW. Each of the pixel electrodes PE opposes the common electrode CE, and the liquid crystal layer LC is driven by the electric field generated between the pixel electrode PE and the common electrode CE. The capacitance CS is formed, for example, between the electrode with the same potential as the common electrode CE and the electrode with the same potential as the pixel electrode PE.

The terminal area MT1 extends along the short side EX of the liquid crystal display panel PNL1. A terminal portion is formed in the terminal area MT1, and the liquid crystal display panel PNL1 is electrically connected to an external device, such as a flexible wiring substrate, via the terminal portion.

The dimming panel PNL2 has basically the same configuration as that of the liquid crystal display panel PNL1. The dimming panel PNL2 comprises a plurality of pixels PX2 provided in a matrix along the first direction X and the second direction Y in the effective area AA1 (display area). The area in which the pixels PX2 are provided is referred to as an effective area AA2. The effective area AA2 has the same size as that of the effective area AA1.

Each of the pixels PX2 corresponds to each respective one of the pixels PX1. Or, one pixel PX2 may correspond to three pixels PX1 corresponding to colors of red (R), green (G) and blue (B). Note that the configuration of the pixels PX2 is similar to that of the pixels PX1, and therefore the above-provided detailed explanation can be used here as well, and will be omitted. In this embodiment, the pixels PX1 and the pixels PX2 have the identical configuration. The pixels PX1 and the pixels PX2 may be the same or different in size. More specifically, the pixels PX1 and the pixels PX2 have the identical layer structures. Further, when the sizes of the pixels PX1 and the pixels PX2 are the same as each other, lengths along each of the first direction X and the second direction Y are the same.

The dimming panel PNL2, as in the case of the liquid crystal display panel PNL1, includes a non-display area NDA2 located on an outer side of the effective area AA2. The non-display area NDA2 includes a terminal area MT2 where a driver IC and a flexible wiring substrate are mounted. The non-display area NDA2 and the terminal area MT2 are similar to the non-display area NDA1 and the terminal area MT1, respectively.

The illumination device ILD is located below the dimming panel PNL2, and images are displayed by controlling the light from the illumination device ILD for each pixel PX. The illumination device ILD of this embodiment is the so-called backlight.

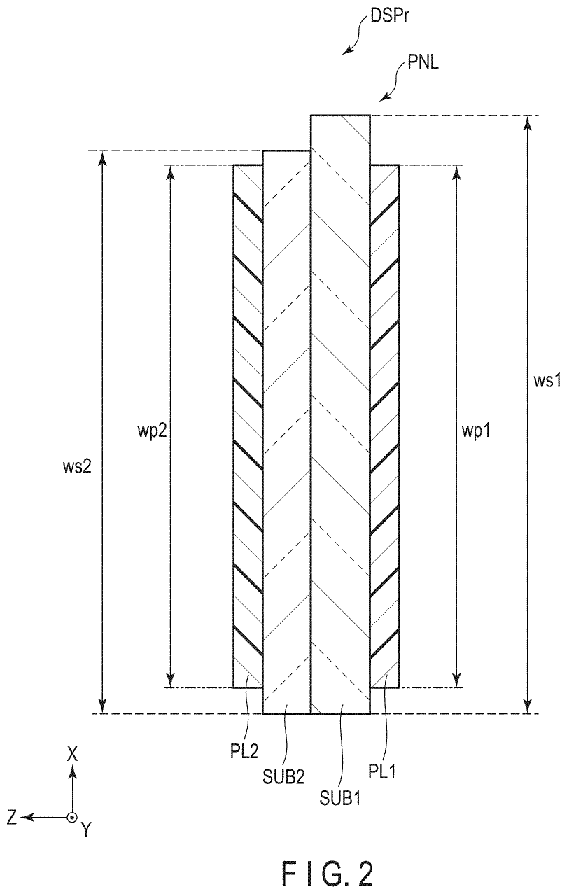

FIG. 2 is a cross-sectional view of a display device according to a comparative example. In a display device DSPr, the liquid crystal display panel PNL1 and the dimming panel PNL2 have the same structure. When the liquid crystal display panel PNL1 and the dimming panel PNL2 are not distinguished from each other, they are referred to as panels PNL. The panels PNL each comprises a substrate SUB1 and a substrate SUB2 opposing each other, a polarizer PL1 attached to on a surface on an opposite side to a surface of the substrate SUB2, which opposes the substrate SUB1, and a polarizer PL2 attached to a surface on an opposite side to a surface of the substrate SUB2, which opposes the substrate SUB1.

A length ws1 is defined as the length of the substrate SUB1 along the first direction X, a length ws2 is defined as the length (width) of the substrate SUB2 along the first direction X, a length wp1 is defined as the length of the polarizer PL1 along the first direction X and a length wp2 is defined as the length of the polarizer PL2 along the first direction X. The length ws1 is greater than the length ws2, length wp1 and length wp2. The length ws2 is greater than the length wp1 and the length wp2. The length wp1 and the length wp2 are the same as each other.

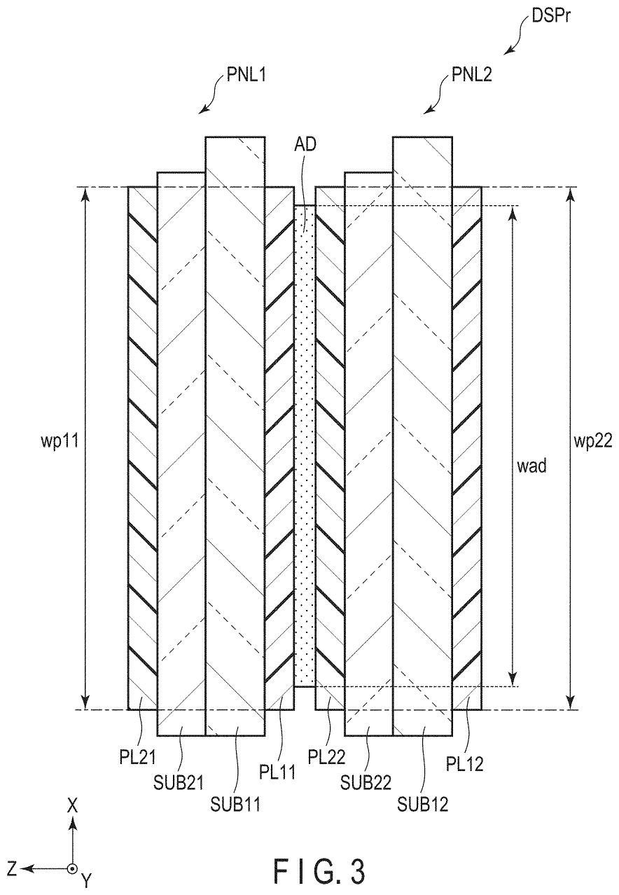

FIG. 3 is a cross-sectional view of a display device according to a comparative example. In a display device DSPr shown in FIG. 3, a liquid crystal display panel PNL1 and a dimming panel PNL2 are bonded together by an adhesive layer AD. The liquid crystal display panel PNL1 and the dimming panel PNL2 each have a configuration similar to that of the panel PNL.

The liquid crystal display panel PNL1 comprises a substrate SUB11, a substrate SUB21, a polarizer PL11, a polarizer PL21 and a liquid crystal layer (not shown) provided between the substrate SUB11 and the substrate SUB21. The polarizer PL11 is attached to a surface of the substrate SUB11, which is on an opposite side to the surface opposing the substrate SUB21. The polarizer PL21 is attached to an surface of the substrate SUB21, which is on an opposite side to the surface opposing the substrate SUB11. The switching elements SW, the pixel electrodes PE, the signal lines SL, the scanning lines GL and the like, described above are provided on the substrate SUB11.

The dimming panel PNL2 comprises a substrate SUB12, a substrate SUB22, a polarizer PL12, a polarizer PL22 and a liquid crystal layer (not shown) provided between the substrate SUB12 and the substrate SUB22. The polarizer PL12 is attached to a surface of the substrate SUB12, which is on an opposite side to the surface opposing the substrate SUB22. The polarizer PL22 is attached to a surface of the substrate SUB22, which is on an opposite side to the surface opposing the substrate SUB12. The switching elements SW, the pixel electrodes PE, the signal lines SL, the scanning lines GL and the like, described above are provided on the substrate SUB12.

The adhesive layer AD is provided between the polarizer PL11 and the polarizer PL22. The adhesive layer AD adheres to the polarizer PL11 and the polarizer PL22, thus adhering the liquid crystal display panel PNL1 and the dimming panel PNL2. The adhesive layer AD can be, for example, an optical clear adhesive (OCA). The adhesive layer AD is superimposed on each of the entire effective area AA1 and the entire effective area AA2. On the other hand, each of the effective area AA1 and the effective area AA2 does not overlap the entire adhesive layer AD. In other words, the adhesive layer AD is superimposed over the effective area AA1 and the effective area AA2 so as to cover each thereof.

Here, a length wp11 is defined as the length of the polarizer PL11 of the liquid crystal display panel PNL1 along the first direction X, a length wp22 is defined as the length of the polarizer PL22 of the dimming panel PNL2 along the first direction X, and a length wad is defined as the length of the adhesive layer AD along the first direction X. The length wp22 and the length w11 are the same as each other and greater than the length wad.

As shown in FIG. 3, if the length wad of the adhesive layer AD is less than the length wp22 of the polarizer PL22 and the length wp11 of the polarizer PL11, the display device DSPr is a normal display device in appearance. However, if the length wad of the adhesive layer AD is greater than the length wp22 and the length w11, the adhesive layer AD protrudes out from the polarizer PL11 and the polarizer PL22. Thus, the display device DSPr becomes to have a poor appearance.

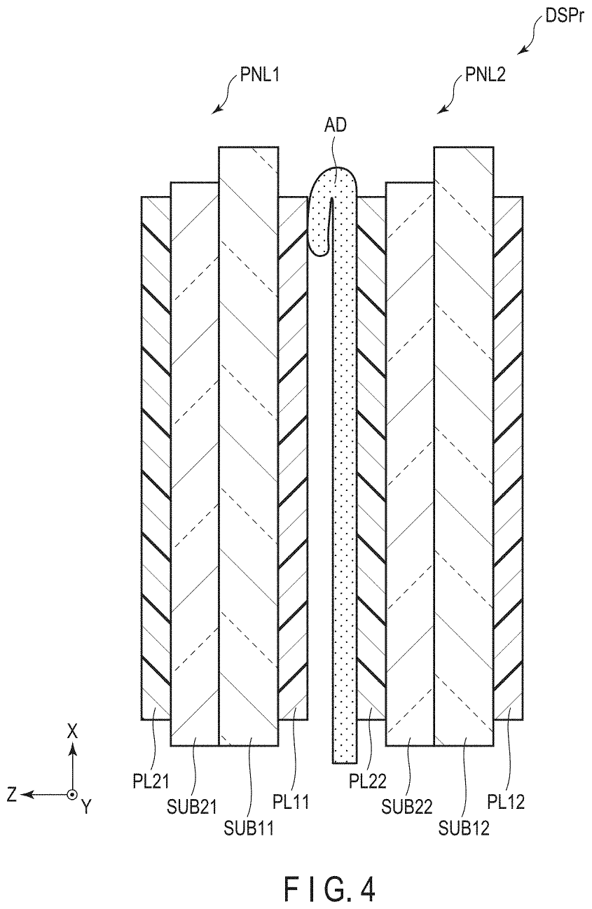

FIG. 4 is a cross-sectional view of a display device in which the adhesive layer AD protrudes. The display device DSPr here entails, not only defective in appearance, but also the following drawback. The adhesive layer AD is attached to one of the polarizers PL22 and the polarizer PL11 from the state where it is provided in contact with the release paper (separator). After peeling off the release paper, the other one of the polarizer PL22 and the polarizer PL11 is bonded to the adhesive layer AD. Here, if the adhesive layer AD protrudes from the polarizer PL22 and the polarizer PL211, it is difficult to peel it off. Further, there is a risk of steps or unevenness formed in the adhesive layer AD. If steps are created in the adhesive layer AD, air bubbles may enter between the adhesive layer AD and the surface of the polarizer.

Further, if the adhesive layer AD protrudes, it may bond with other components. Furthermore, foreign substances may be bonded, which may adversely affect the reliability and the like of the display device DSPr.

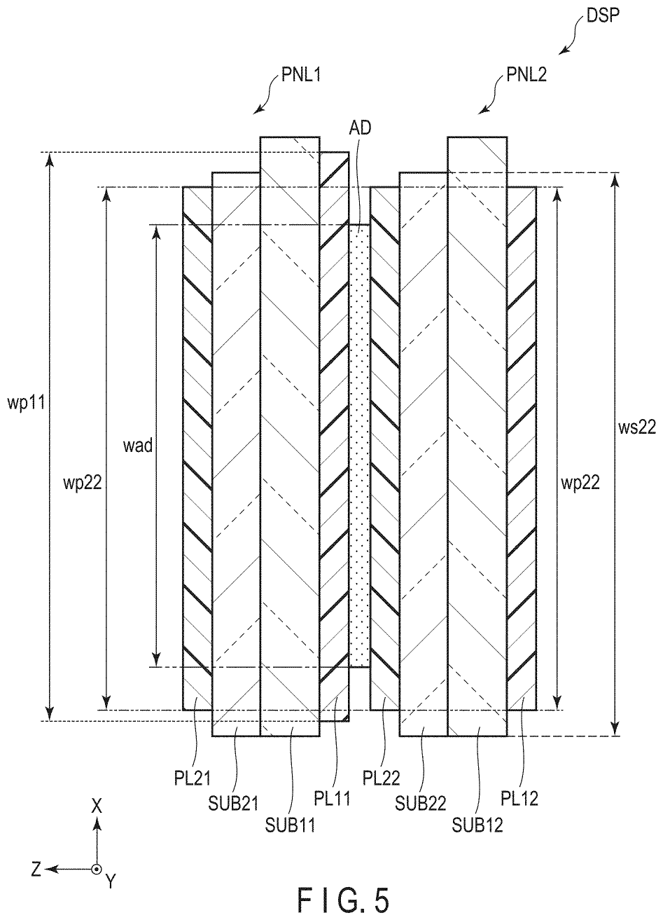

FIG. 5 is a cross-sectional view schematically showing an example of the display device of this embodiment. In the display device DSP, a length wad is defined as the length of the adhesive layer AD along the first direction X, a length wp11 is defined as the length of the polarizer PL11 of the liquid crystal display panel PNL1 along the first direction X, a length wp22 is defined as the length of the polarizer PL22 of the dimming panel PNL2 along the first direction X, and a length ws22 is defined as the length of the substrate SUB22 along the first direction X. The relationship of the lengths of the structural components of the dimming panel PNL2 along the first direction X may be the same as the relationship of the lengths of the panels PNL shown in FIG. 2.

The length wp11 of the polarizer PL11 of the liquid crystal display panel PNL1 is greater than the length of the polarizer PL11 of the display unit DSPr shown in FIG. 3. The length wp22 of the polarizer PL22 of the dimming panel PNL2 is less than the length ws22 of the substrate SUB22 (wp22<ws22). The length wad of the adhesive layer AD is less than the length wp22 of the polarizer PL22 (wad22<wp22). The length wp11 of the polarizer PL11 of the liquid crystal display panel PNL1 is greater than the length wp11 of the adhesive layer AD (wp11>wad). The length wp11 of the polarizer PL11 is greater than the length wp22 of the polarizer PL22 of the dimming panel PNL2 (wp11>wp22). In other words, the following relationships: wp22<ws22 and wad<wp11<wp22 (Relationship 1) are established.

Further, as shown in FIG. 5, the length wp11 of the polarizer PL11 is greater than the length ws22 of the substrate SUB22 (wp11>ws22). Therefore, the following relationship: wad<wp22<ws22<wp11 (Relationship 2) is established.

Note that the polarizer PL22, the polarizer PL12 and the polarizer PL21 other than the polarizer PL11 may have the same size.

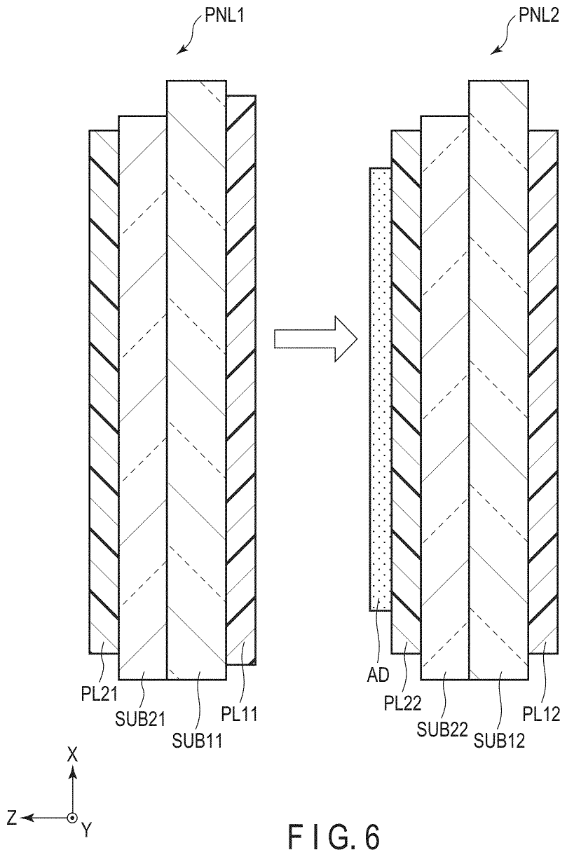

FIG. 6 is a cross-sectional view showing a processing step of attaching a liquid crystal display panel to a display panel. The adhesive layer AD is provided on the polarizer PL22 from the release paper described above. Then, the liquid crystal display panel PNL1 is adhered as the polarizer PL11 is attached to the adhesive layer AD. If the length wp11 of the polarizer PL11 is greater than the length wad (wad<wp11), the adhesive layer AD does not protrude from the polarizer PL11.

If the polarizer PL11 is longer than the polarizer PL22 (wp21<wp11), the adhesive layer AD is entirely attached to the polarizer PL11 and therefore the adhesive layer AD will not bend toward the polarizer PL22.

The polarizer PL11 and the polarizer PL21 of the liquid crystal display panel PNL1 have their polarization axes crossing each other. The polarizer PL12 and the polarizer PL22 of the dimming panel PML2 have their polarization axes crossing each other. The polarization axes of the polarizer PL11 and the polarizer PL22, which oppose each other while interposing the adhesive layer AD therebetween, may be parallel to each other. In that case, the polarizer PL22 may be omitted.

When the polarizer PL22 is omitted, the adhesive layer AD is first provided on the substrate SUB22. After that, the polarizer PL11 is adhered to the adhesive layer AD. Thus, the liquid crystal display panel PNL1 is adhered to the dimming panel PNL2.

By omitting the polarizer PL22, the gap between the liquid crystal display panel PNL1 and the dimming panel PNL2 can be reduced. If the gap is large, there is a risk that displayed images may be visually recognized in double. By reducing the panel gap, double images can be prevented from occurring, thereby making it possible to improve the display quality.

For example, the thickness of the polarizer (the length along the third direction Z) should be 0.2 mm or more and 0.3 mm or less, and more preferably, 0.25 mm. The thickness of the adhesive layer AD is 0.05 mm or more and 0.3 mm or less, and more preferably 0.2 mm. When the polarizer PL22 is omitted, for example, the gap between the liquid crystal display panel PNL1 and the dimming panel PNL2 becomes smaller by 0.25 mm.

In this embodiment, at least the substrate SUB11, the substrate SUB12 and the substrate SUB22 have the same size. That is, these substrates have the same length along the first direction X and the second direction Y, respectively. In this case, the substrate SUB12 is larger than the substrate SUB11, the substrate SUB12 and the substrate SUB2. Alternatively, the substrate SUB11, the substrate SUB12, the substrate SUB12 and the substrate SUB22 may all be the same in size. The substrate SUB11, the substrate SUB12, the substrate SUB12 and the substrate SUB22 each include a plate-shaped glass as a base. The thickness (length along the third direction Z) of the base may be, for example, 0.2 mm.

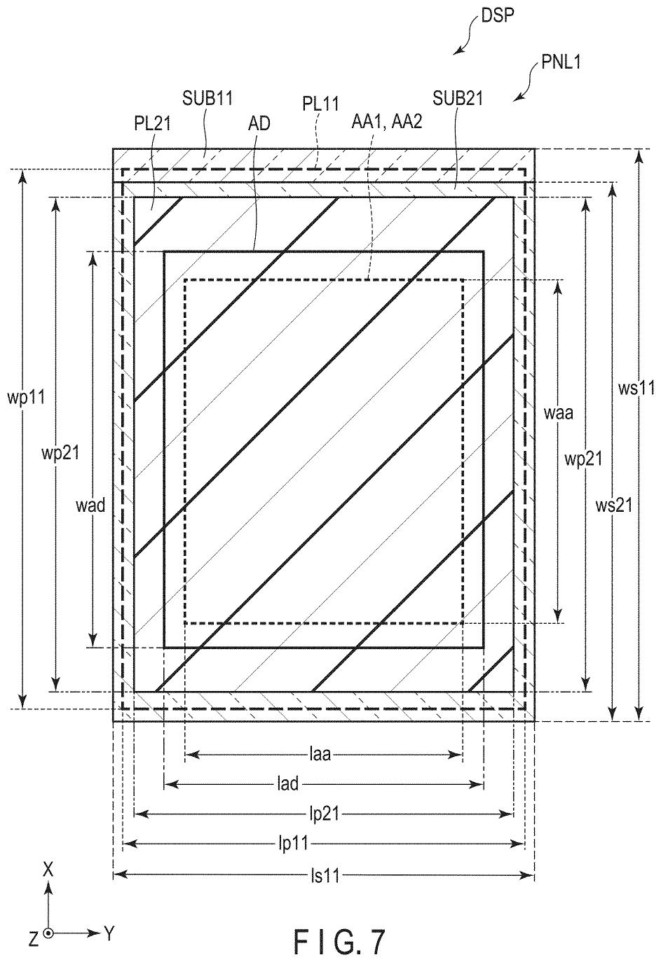

FIG. 7 is a plan view schematically showing an example of the display device of this embodiment. FIG. 7 corresponds to a top view of the display device DSP shown in FIG. 5 as taken from an opposite direction of the third direction Z, that is, from the top of the page. In FIG. 7, a length ws21 is defined as the length of the substrate SUB21 of the liquid crystal display panel PNL1 along the first direction X.

Here, a length lad is defined as the length of the adhesive layer AD along the second direction Y, a length lp11 is defined as the length of the polarizer PL11 along the second direction Y, a length lp21 is defined as the length of the polarizer PL21 along the second direction Y, and a length ls11 is defined as the length of the substrate SUB11 along the second direction Y. The length of the substrate SUB21 along the second direction Y is the same as the length ls11. From FIG. 6, the following relationships can be established: the length lad is less than the length lp21, the length lp21 is less than the length lp11, and the length lp11 is less than the length ls11 (lad<lp21<lp11<ls11 (Relationship 3)).

Note that as described above, the adhesive layer AD covers the effective area AA1 and the effective area AA2. In FIG. 7, it assumed that the effective area AA1 and the effective area AA2 have the same size, and a length waa is defined as the length along the first direction X and a length laa is defined as the length along the second direction Y. The length wad is greater than the length waa and the length lad is greater than the length laa.

In this embodiment, the adhesive layer AD of the display device DSP can attach the liquid crystal display panel PNL1 and the dimming panel PNL2 without protruding out during the attaching process. In this manner, defective appearance can be prevented. Further, no air bubbles or foreign matter are mixed thereinto due to improper attachment, a highly reliable display device can be obtained.

In this disclosure, the substrate SUB11, the substrate SUB21, the substrate SUB12 and the substrate SUB22 may as well be referred to as a first substrate, a second substrate, a third substrate and a fourth substrate, respectively. The polarizer PL11, the polarizer PL21, the polarizer PL12 and the polarizer PL22 may as well be referred to as a first polarizer, a second polarizer, a third polarizer and a fourth polarizer, respectively. The effective area AA1 and the effective area AA2 may as well be referred to as a first effective area and a second effective area, respectively. The pixel PX1 of the liquid crystal display panel PNL1 may as well be referred to as a first pixel and the pixel PX2 of the dimming panel PNL2 may as well be referred to as a second pixel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a liquid crystal display panel comprising:
a first substrate,
a second substrate opposing the first substrate,
a first polarizer attached to a surface of the first substrate, which is on an opposite side to a surface opposing the second substrate,
a second polarizer attached to a surface of the second substrate, which is on an opposite side to a surface opposing the first substrate,
a first liquid crystal layer provided between the first substrate and the second substrate, and
a first effective area in which a plurality of first pixels are provided;
a dimming panel; and
an adhesive layer provided between the liquid crystal display panel and the dimming panel, wherein
the adhesive layer is in contact with the first polarizer,
the adhesive layer overlaps the first effective area, entirely, and
a length of the adhesive layer along the first direction is less than a length of the first polarizer along the first direction.

2. The display device according to claim 1, wherein
the dimming panel comprises
a third substrate,
a fourth substrate opposing the third substrate,
a third polarizer attached to a surface of the third substrate, which is on an opposite side to a surface opposing the fourth substrate,
a fourth polarizer attached to a surface of the fourth substrate, which is on an opposite side to a surface opposing the third substrate,
a second liquid crystal layer provided between the third substrate and the fourth substrate, and
a second effective area in which a plurality of second pixels are provided, and
the adhesive layer is provided between the first polarizer and the fourth polarizer, and
a length of the adhesive layer along the first direction is less than a length of the fourth polarizer along the first direction.

3. The display device according to claim 1, wherein
the dimming panel comprises
a third substrate,
a fourth substrate opposing the third substrate,
a third polarizer attached to a surface of the third substrate, which is on an opposite side to a surface opposing the fourth substrate,
a fourth polarizer attached to a surface of the fourth substrate, which is on an opposite side to a surface opposing the third substrate,
a second liquid crystal layer provided between the third substrate and the fourth substrate, and
a second effective area in which a plurality of second pixels are provided, and
the adhesive layer is provided between the first polarizer and the fourth polarizer, and
a length of the fourth polarizer along the first direction is less than a length of the first polarizer along the first direction.

4. The display device according to claim 1, wherein
the dimming panel comprises
a third substrate,
a fourth substrate opposing the third substrate,
a third polarizer attached to a surface of the third substrate, which is on an opposite side to a surface opposing the fourth substrate,
a fourth polarizer attached to a surface of the fourth substrate, which is on an opposite side to a surface opposing the third substrate,
a second liquid crystal layer provided between the third substrate and the fourth substrate, and
a second effective area in which a plurality of second pixels are provided, and
the adhesive layer is provided between the first polarizer and the fourth polarizer, and
a length of the fourth polarizer along the first direction is less than a length of the fourth substrate along the first direction.

5. The display device according to claim 1, wherein
the dimming panel comprises
a third substrate,
a fourth substrate opposing the third substrate,
a third polarizer attached to a surface of the third substrate, which is on an opposite side to a surface opposing the fourth substrate,
a second liquid crystal layer provided between the third substrate and the fourth substrate, and
a second effective area in which a plurality of second pixels are provided, and
the adhesive layer is provided between the first polarizer and the fourth substrate.

6. The display device according to claim 1, wherein
the adhesive layer is an optical clear adhesive (OCA).
